(19) United States
(12) Patent Application Publication
(10) Pub. No.: US 2006/0077919 A1
(43) Pub. Date: Apr. 13, 2006

(54) Automatic retransmit request protocol for channels with time-varying capacity

(76) Inventor: Anthony Gerkis, Richmond Hill (CA)

Correspondence Address: KATTEN MUCHIN ROSENMAN LLP, 525 WEST MONROE STREET, CHICAGO, IL, 60661-3693, US

(21) Appl. No.: 10/522,739

(22) PCT Filed: Jul. 31, 2003
(86) PCT No.: PCT/CA03/01131

§ 371 Date: Jan. 28, 2005

(30) Foreign Application Priority Data
Jul. 31, 2002 (CA) 2396213

(51) Int. Cl. H04J 3/08; H04B 7/14

(52) U.S. Cl. 370/315

(57) ABSTRACT

A method and system for transmitting data to a receiver over a data link in frames whose data-carrying capacity may vary from frame to frame. When data-carrying capacity is made available in a frame, the data is transmitted in one or more protocol units, each protocol unit having a data payload portion that is implicitly divided into sequentially numbered blocks each having the same fixed length, except if the number of bytes carried in the payload portion is not an integer multiple of the fixed length, then the last block, or the only block if the number of bytes in the payload portion is less than the fixed length, is shorter than the fixed length, and a header portion including the sequence number of the first block in the data payload portion. If it is determined that the receiver did not receive an uncorrupted copy of a previously transmitted protocol unit and there is insufficient data-carrying capacity in the next available frame, then the previously transmitted protocol unit is transmitted in two or more new protocol units formed from the blocks of the previously transmitted protocol unit.

### FIELD OF THE INVENTION

The present invention relates generally to a method and system for transmitting data from a radio transmitter to a receiver. More specifically, the present invention relates to a method and system for reliably transmitting data between stations, such as the radio base station and subscriber stations in a wireless local loop system, or the like, in which data transmissions are packaged in protocol units whose payload portions vary in data-carrying capacity.

### BACKGROUND OF THE INVENTION

Canadian Patent Application Number 2,345,507, which filed on Apr. 30, 2001 and assigned to the assignee of this application, and which is hereby incorporated by reference in its entirety, discloses a method and system for transmitting data between stations, such as the radio base station and subscriber stations in a wireless local loop system, or the like, in which data transmissions are sent in frames having a fixed duration in time. Each subscriber station intermittently reports to the base station the reception quality of signals transmitted by the base station. Each transport block includes the same predefined number of traffic symbols, and includes a header portion and a payload portion. The header portion of each block is packaged for transmission in a robust manner, enhancing the probability that each subscriber station will be able to recover it and the header portion includes information required to recover the payload portion. The payload portion is, in accordance with the reception quality reported by the intended recipient subscriber station, packaged to make efficient use of the transmission resources while ensuring a reasonable probability that the intended recipient subscriber station will be able to recover the payload. The header portion can include indications of the modulation, forward error correction and repetition utilized to package the payload and can indicate the length of the payload. The result is that the data-carrying capacity available to transmit data to a subscriber station can vary from frame to frame due to variation in reception quality at the subscriber station.

Data transmission errors will inevitably occur in a wireless data transmission systems. One method for correcting errors is commonly referred to as “Automatic Repeat reQuest” or “ARQ”. In this method, when data is transmitted in protocol units a received protocol unit is not accepted by the receiver if it is determined by the receiver to be unreliable. The receiver, either explicitly or implicitly, requests retransmission of the suspect protocol unit. Retransmissions may also be requested if a protocol unit appears to have been lost.

Implementation of ARQ in a system such as that disclosed in Canadian Patent Application Number 2,345,507, is not as straight-forward as in a system in which the data-carrying capacity of protocol units is fixed. Retransmission should preferably occur as soon as a request for retransmission is received by the transmitter, but if the data-carrying capacity of frames varies, it may be that retransmission of a lost or corrupted protocol unit is not possible as the protocol unit may be too large to fit in the next frame or perhaps even in a number of successive frames. In a situation in which low latency is required, this may not be acceptable. One way to handle this is to limit the size of the payload portion of the protocol units, so that protocol units may be retransmitted even if the data-carrying capacity available is reduced. However, doing so increases the overhead because more headers needed as more protocol units are needed to send the same amount of data, which decreases the throughput of data. A method and system is needed for providing ARQ in systems in which the data-carrying capacity of frames varies, but which keeps overhead low and throughout high.

### SUMMARY OF THE INVENTION

According to one aspect of the invention, there is provided a system and method for transmitting ordered data to a receiver over a data link in frames whose data-carrying capacity may vary from frame to frame. The data is transmitted in implicitly sequentially numbered blocks transmitted in at least one series of blocks, each series having at least one block. The blocks have lengths determined so that the receiver can identify the blocks by sequence number using the sequence number of the first block of each series of blocks and can individually request retransmission of a lost or corrupted block. Preferably, the sequentially numbered blocks of a series each have a fixed length, except for the last block of a series, or the only block of a series that has only one block, which may be shorter. The total number of sequence numbers available for numbering the blocks may be pre-selected so that the bandwidth-delay product of the data link under ideal conditions divided by the total number of sequence numbers available for numbering the blocks is not greater than the lowest data-carrying capacity that is reasonably likely to be available in a frame to transmit a series of blocks over the data link during normal operation of the data link. The fixed length may initially be set to be greater than the bandwidth-delay product of the data link under during normal operation of the data link divided by the total number of sequence numbers available for numbering the blocks and less than the maximum data-carrying capacity that is reasonably likely to be available in a frame to transmit a series of blocks over the data link during normal operation of the data link. Fixed length may be reset if the bandwidth-delay product of the data link changes so that the fixed length is within a predetermined tolerance of the bandwidth-delay product of the data link divided by the total number of sequence numbers available for numbering the blocks or the maximum data-carrying capacity that is available in a frame to transmit a series of blocks over the data link. Each series of blocks is preferably encapsulated in a protocol unit together with a header that includes the sequence number of the first block of the series of blocks.

According to another aspect of the invention, when data-carrying capacity is made available in a frame, the data is transmitted in one or more protocol units. Each discrete protocol unit has a data payload portion that is implicitly divided into sequentially numbered blocks each having the same fixed length, except that the last block, or the only block if the protocol unit has only one block, is shorter if the data payload portion is not an integer multiple in length of the fixed length. Each protocol unit also has a header portion including the sequence number of the first block in its data payload portion. The sequence numbers are chosen so that all blocks transmitted over the data link can be identified as to sequence number by the receiver. If the receiver determines that it did not receive an uncorrupted copy of a previously transmitted protocol unit, then the transmitter retransmits the previously transmitted protocol unit in the next available frame to be transmitted if there is sufficient data-carrying capacity in the next available frame. If there is not sufficient data-carrying capacity in the next available frame, the transmitter forms a new protocol unit from the blocks of the previously transmitted protocol unit starting with the first block of the previously transmitted protocol unit and proceeding sequentially through the previously transmitted protocol unit adding blocks to the newly formed protocol unit until the data-carrying capacity of the next available frame is used or a block is encountered that is not the fixed length or is larger than the remaining available data-carrying capacity. If (1) there is remaining available data-carrying capacity, (2) the last block of the previously transmitted protocol unit is the fixed length, and (3) the next previously transmitted protocol unit that is to be retransmitted is consecutive to the previously transmitted protocol unit, then consecutive blocks from that next previously transmitted protocol unit are added until (1) the last block to be added is not the fixed length, (2) the next block to be added is larger than the remaining available data-carrying capacity, or (3) all of the blocks of that next previously transmitted protocol unit have been added. If there is still remaining available data-carrying capacity, then this process is repeated. The newly formed protocol unit is then transmitted in the next available frame over the data link. Further new protocol units are formed and transmitted in the same manner whenever data-carrying capacity in a frame is available until all blocks of all previously transmitted protocol units that have to be retransmitted have been successfully retransmitted. Each newly formed protocol unit has a header including the sequence number of the first block in its data payload portion. If the data-carrying capacity of any frame is not fully utilized in retransmitting previously transmitted blocks, then any remaining data-carrying capacity is filled with new protocol units formed from data that has not previously been transmitted.

According to another aspect of the invention, there is provided a system for transmitting data over a data link, including a receiver and a transmitter. The receiver has a microprocessor, a modem, a radio and an antenna, and is capable of receiving frames transmitted over the data link. The data-carrying capacity of the frames may vary from time to time. The transmitter includes a microprocessor, a modem, a radio and an antenna, and is operable to transmit frames to the receiver over the data link. The frames include one or more protocol units. Each discrete protocol unit has a data payload portion that is implicitly divided into sequentially numbered blocks each having a fixed length, except if the number of bytes carried in the payload portion is not an integer multiple of the fixed length, then the last block (or the only block if the number of bytes in the payload portion is less than the fixed length) is shorter than the fixed length. The protocol units also have a header portion including the sequence number of the first block in the data payload portion. The sequence numbers are chosen so that all blocks transmitted over the data link can be identified by sequence number. If it is determined that the receiver did not receive an uncorrupted copy of a previously transmitted protocol unit, then the transmitter retransmits the previously transmitted protocol unit in the next available frame to be transmitted if there is sufficient data-carrying capacity in the next available frame. However, if there is insufficient data-carrying capacity in the next available frame, the transmitter forms a new protocol unit from the blocks of the previously transmitted protocol unit starting with the first block of the previously transmitted protocol unit and proceeding sequentially through the previously transmitted protocol unit adding blocks to the newly formed protocol unit until the data-carrying capacity of the next available frame is used. The newly formed protocol unit is then transmitted the over the data link. If not all of the blocks of the previously transmitted protocol unit have been transmitted in the new protocol unit, then further new protocol units are formed and transmitted whenever data-carrying capacity in a frame is available until all blocks of the previously transmitted protocol unit have been successfully retransmitted. Each newly formed protocol unit has a header including the sequence number of the first block in its data payload portion.

According to yet another aspect of the invention, there is provided a protocol unit for transmitting data to a receiver over a data link in frames whose data-carrying capacity may vary from frame to frame. The protocol unit includes a data payload portion that is implicitly divided into sequentially numbered blocks each having a fixed length, except if the number of bytes carried in the payload portion is not an integer multiple of the fixed length, then the last block (or the only block if the number of bytes in the payload portion is less than the fixed length) is shorter than the fixed length. The protocol unit also has a header portion that includes the sequence number of the first block in the data payload portion. The sequence numbers are chosen so that the receiver can identify all blocks transmitted over the data link by sequence number.

### BRIEF DESCRIPTION OF THE DRAWINGS

Preferred embodiments of the present invention will now be described, by way of example only, with reference to the attached Figures, in which:

FIG. 1 is a schematic representation of an exemplary network in which a system and method for providing ARQ in accordance with an embodiment of the invention may be provided;

FIG. 2 is a schematic representation of the base station shown in FIG. 1;

FIG. 3 is a schematic representation of one of the subscriber stations shown in FIG. 1;

FIGS. 4a, 4b and 4c are schematic representations of a frame of data blocks for transmission over the network shown in FIG. 1 at three different spreading factors;

FIG. 5 is a schematic representation of a block in the frames of FIG. 4a;

FIG. 6 is a flowchart of a method of constructing the block of FIG. 5; and

FIG. 7 is a flowchart showing how ARQ may be provided in the network shown in FIG. 1 if transmitted frames may vary in data-carrying capacity.

### DETAILED DESCRIPTION OF THE INVENTION

Referring now to FIG. 1, an exemplary wireless network system for transmitting data is indicated generally by reference numeral 20. System 20 is described in detail below so that the reader can understand the context for the embodiment of the invention that is then described. However, the following description of system 20 should not be taken to limit the scope of the invention, which may be useful in a wide range of telecommunications networks in which it may be desirable to transmit data in protocol units whose data-carrying capacity may vary from time to time.

System 20 includes a radio base station 24 and a plurality of subscriber stations 28a, 28b . . . 28n. A radio base station 24 is connected to at least one data telecommunications network (not shown), such as a land line-based switched data network, a packet network, etc., by an appropriate gateway and one or more backhauls (not shown), such as a T1, T3, E1, E3, OC3 or other suitable land line link, or can be a satellite or other radio or microwave channel link or any other link suitable for operation as a backhaul as will occur to those of skill in the art.

Base station 24 communicates with subscriber stations 28, which are installed at subscriber premises, as is common in a wireless local loop system. The number ‘n’ of subscriber stations serviced by a base station 24 can vary depending upon the amount of radio bandwidth available and/or the configuration and requirements of the subscriber stations 28.

A data channel 32 is established between base station 24 and each subscriber station 28 via radio. Data channel 32 carries information to be transferred from base station 24 to respective subscriber stations 28a, 28b . . . 28n as needed. Data channel 32 can be implemented with networks using a variety of multiple access techniques, including TDMA, FDMA, CDMA or hybrid systems such as GSM, etc. In the exemplary system 20, data transmitted over data channel 32 is transmitted as packets encapsulated within frames, the details of which will be discussed in greater detail below.

The ability of a subscriber station 28 to properly receive a signal transmitted to it, hereinafter referred to as the “reception quality” of the signal, can depend upon a variety of factors. Measures of reception quality can be determined in different manners according to the multiple access technique employed to transmit the signal. For example, in TDMA or FDMA systems, the received signal strength is the determination most often used. In CDMA systems, the ratio of received bit power to received interference power (often expressed as Eₛ/Nₒ, where Eₛ is energy per symbol, and Nₒ is the received interference energy) is a relevant determination. In any event, the reception-quality of channel 32 at each subscriber station 28 can vary depending on a variety of factors, including multipath interference (from the presence of nearby buildings, etc.), radio noise sources (including transmissions by other users or radio noise sources), geographical features, the distance of the subscriber station 28 from base station 24, the quality of the receiver in the subscriber station 28, etc. as is well understood by those of skill in the art. With distance, typically a signal attenuates as 1/r^{N}, where r is the distance between the subscriber station 28 and base station 24, and N>1. In IS-95 CDMA systems, for example, N typically is in the range of 3<N<5.

As illustrated in FIG. 1, the geographic distribution of subscriber stations 28 with respect to base station 24 need not be symmetric nor will subscriber stations that are physically located close to one another necessarily experience the same or similar reception qualities due to a variety of factors including the geographic environment (the presence or absence of buildings which can reflect or mask signals), the radio environment (the presence or absence of radio noise sources), etc. Thus, in most circumstances subscriber stations 28 served by a base station 24 can have significantly different reception qualities and these reception qualities can change over time.

In FIG. 1, at one time subscriber stations 28a and 28f may experience a very good reception quality while subscriber stations 28b and 28g experience moderate reception quality and subscriber stations 28c, 28d and 28e may experience low reception quality. At a subsequent time, subscriber stations 28a, 28d and 28g can have very good reception, subscriber stations 28c, 28e and 28f may experience moderate reception quality and subscriber station 28b may experience low reception quality, etc.

At appropriate intervals or at predetermined events, each subscriber station 28 reports its present reception-quality to base station 24. Base station 24 operates to maintain a database of the latest reported reception-qualities and appropriately packages data to be transmitted over data channel 32 to each subscriber station 28.

As used herein, the terms “package”, “packaged” and “packaging” refer to the overall arrangement of the transmission of the packaged data for its reception at an intended destination receiver. Packaging of data can include, without limitation, applying different levels of forward error correcting (FEC) codes (from no coding to high levels of coding and/or different coding methods), employing various levels of symbol repetition, employing different modulation schemes (4-QAM, 16-QAM, 64-QAM, etc.) and any other techniques or methods for arranging data transmission with a selection of the amount of radio (or other physical layer) resources required, the data rate and probability of transmission errors which are appropriate for the transmission. For example, data can be packaged with rate ¼ FEC coding (each 1 data bit is transmitted in 4 bits of information) and 16-QAM modulation for transmission to a first intended receiver and packaged with rate ½ FEC coding and 64-QAM modulation for transmission to a second intended receiver which has a better reception-quality than the first.

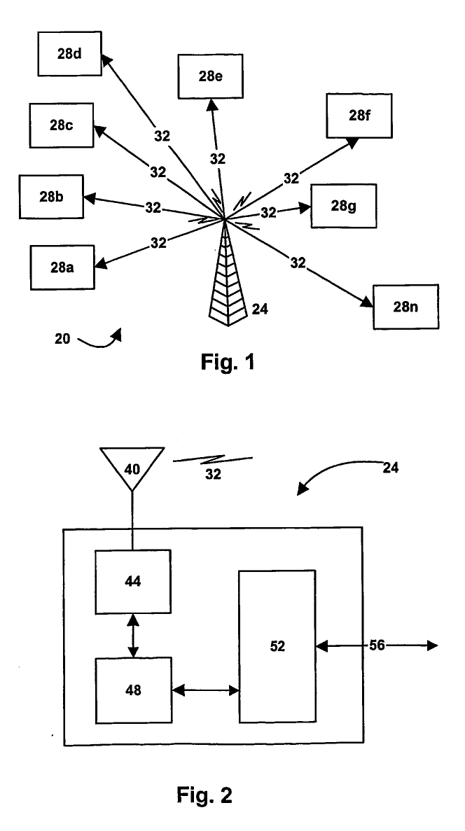

FIG. 2 shows an example of base station 24 in greater detail. Base station 24 comprises an antenna 40, or antennas, for receiving and transmitting radio-communications over communication channel 32. In turn, antenna 40 is connected to a radio 44 and a modem 48. Modem 48 is connected to a microprocessor-router assembly 52 such as a SPARC processor system manufactured by SUN Microsystems. It will be understood that assembly 52 can include multiple microprocessors, as desired and/or that the router can be provided as a separate unit, if desired. The router within microprocessor-router assembly 52 is connected to a backhaul 56 in any suitable manner, which in turn connects base station 24 to a data network (not shown).

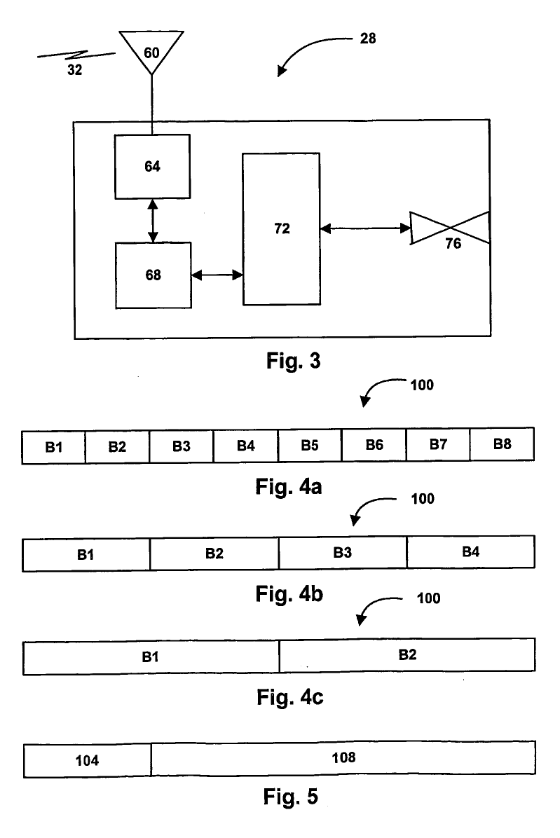

Referring now to FIG. 3, an example of a subscriber station 28 is shown in greater detail. Subscriber station 28 comprises an antenna 60, or antennas, for receiving and transmitting radio-communications over communication channel 32. In turn, antenna 60 is connected to a radio 64 and a modem 68, which in turn is connected to a microprocessor-assembly 72.

Microprocessor-assembly 72 can include, for example, a StrongARM processor manufactured by Intel, that performs a variety of functions, including implementing A/D-D/A conversion, filters, encoders, decoders, data compressors, de-compressors and/or packet disassembly. As seen in FIG. 3, microprocessor-assembly 72 interconnects modem 68 and a data port 76, for connecting subscriber station 28 to a data client device, such as a personal computer, personal digital assistant or the like which is operable to use data received over communication channel 32. Accordingly, microprocessor-assembly 72 is operable to process data between data port 76 and modem 68.

Referring now to FIGS. 4a through 4c, a frame for transmission over channel 32 is indicated generally at 100. Data is transmitted over channel 32 in frames 100 that require ten milliseconds of transmission time, although longer or shorter transmission times for frame 100 can be selected if desired.

As understood by those of skill in the art, frame 100 can be measured in terms of a duration of time. In turn, that duration can carry a given number of symbols for transmission. In turn, those symbols can represent data, the actual amount of data being represented by a symbol depending on how the data is packaged into a symbol. In a CDMA embodiment, symbols can be packaged using a combination of the CDMA spreading factor, modulation, repetition, and encoding. Thus, it will be appreciated that, while the duration of frame 100 remains constant, the effective amount of data transmitted within a frame will depend on the packaging of the data. The application of these concepts to the exemplary system will be discussed in greater detail below.

In the exemplary system, a frame 100 is configured to transmit a number of data blocks B₁ through Bᵢ, where each block Bᵢ carries a fixed number of traffic symbols and thus the number of blocks in a frame 100 depends upon the CDMA spreading factor, chip rate and the transmission duration of the frame, and the amount of forward error correction encoding and modulation type. In the exemplary system, a CDMA system with a chip rate of three-million, eight-hundred and forty thousand chips per second (3.84 Mcps) is employed and a block Bᵢ with one-thousand two-hundred traffic symbols is employed.

FIG. 4a shows frame 100 employed with a CDMA spreading factor of four, so that eight blocks (B₁ through B₈) are included in frame 100 and frame 100 thus includes nine-thousand, six-hundred traffic symbols. In FIG. 4b, a CDMA spreading factor of eight is used, so frame 100 includes four blocks (B₁ through B₄) and four-thousand, eight-hundred traffic symbols and in FIG. 4c, a CDMA spreading factor of 16 is employed, so frame 100 includes two blocks (B₁ and B₂) for two-thousand, four-hundred traffic symbols. By maintaining the number of traffic symbols in blocks B constant and the frame duration constant, undesired complexity at modem 68 can be avoided, although it is contemplated that frame structures with different numbers of traffic symbols can be employed, if desired.

Each block Bᵢ has the structure shown in FIG. 5, including a header 104 and payload 108. It is intended that header 104 be receivable by all subscriber stations 28 in system 20 that have at least a predetermined minimum reception quality. Accordingly, header 104 is packaged in a robust manner to increase the probability that subscriber stations 28 will be able to receive it (i.e.—the frame error rate, or FER, for subscriber stations to receive and understand header 104 is less than a level selected by the operator of system 20). In the exemplary system 20, header 104 comprises ten header information bits which are ultimately packaged into one-hundred and twenty traffic symbols by: coding the information bits for forward error correction (FEC) to yield thirty coded bits (a rate ⅓ FEC code); using a repetition factor of eight to repeat the resulting bits for eight repetitions to obtain two-hundred and forty bits; and then modulating those bits using QPSK modulation to yield the one-hundred and twenty traffic symbols of header 104. While this packaging is presently preferred for header 104, it is contemplated that a wide range of other packagings can be employed for header 104, as will be apparent to those of skid in the art.

Of the ten header information bits of header 104, five bits are presently employed to represent a Length value and the remaining five bits to represent a Block Format.

In the exemplary system 20, while header 104 is packaged to be receivable by all subscriber stations 28, payload 108 is packaged to provide efficient use of radio channel 32 when transmitting information to an intended recipient subscriber station 28. Accordingly, the modulation, FEC coding; symbol repetitions, etc. of payload 108 will be varied from block B to block B, depending upon the intended recipient subscriber station 28 and its reception quality.

In the exemplary system 20, a symbol repetition factor of four, three, two or one can be employed; modulation schemes of 64-QAM; 16-QAM; 4-QAM can be employed; and eight different FEC puncturing masks can be employed (to obtain code rates from ⅓ to ⅘). Further, a length multiplier is required to be available to the receiver so that it can correctly interpret the contents of payload 108 and in the exemplary system 20, multiplier values of eight, sixteen, thirty-two, sixty-four and one-hundred and twenty-eight can be employed. Thus, the particular modulation scheme can be represented with two bits of information (to select from four possible modulations); the symbol repetition factor with two bits (to select from four possible repetition rates); the FEC puncture mask with three bits (to select from eight possible puncture masks), the length multiplier with three bits (to select from five possible multiplier values). However, as will be apparent to those of skill in the art, many combinations of these parameters are redundant, contradictory or are unlikely to be useful in system 20. For example, transmissions at 64-QAM modulation with no symbol repetition and low levels of FEC coding are unlikely to be required in system 20.

Accordingly, to reduce the overhead (header 104) required to transmit the payload 108, thirty-two selected combinations, which are deemed most useful, of the modulation, FEC puncture mask, length multiplier and symbol repetition factors are selected and these combinations are defined as entries in a look up table, known to base station 24 and subscriber stations 24 and the entries of which can be accessed by five bits of information which comprise the Block Format. The actual combinations of factors selected for inclusion in the look up table are not particularly limited and it is contemplated that they will be selected by the manufacturer of base stations 24 and subscriber stations 28 in view of the expected range of operating conditions of a system 20.

The remaining five information bits of header 104 represent a Length parameter that represents the value to be multiplied by the length multiplier from the Block Format, to determine the number of information bits in the payload 108, as this number is necessary for a receiver to know before attempting to interpret payload 108. Essentially, the Length and length multiplier parameters are employed to determine if payload 108 is less than full with valid bits (which can occur depending upon the FEC coding, modulation, and repetition levels used to transmit and the amount of data to be transmitted). As blocks B always have the same number of traffic symbols, pad symbols are added to payload 108 to fill it, if necessary and, to save computational complexity, these pad bits are added after FEC coding, repetition and interleaving has been performed on the payload symbols (as described below). Accordingly, information as to the actual length of payload 108 is required by the receiver to allow for de-interleaving, FEC de-coding, etc. to be performed correctly on the payload 108.

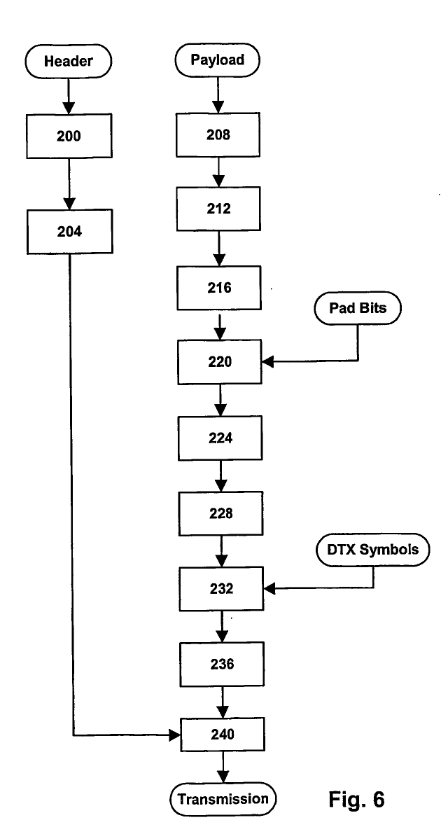

FIG. 6 shows a flowchart of the process of constructing a block B for transmission. As shown, the ten information bits of header information are first FEC encoded at 200 to yield thirty encoded bits for a rate ⅓ FEC code. In the exemplary system 20, a second order Reed-Muller coder is employed, although other suitable coders will also occur to those of skill in the art, which also performs a symbol repetition of order eight to obtain two-hundred and forty encoded bits. Next, the encoded bits are mapped to appropriate symbols for transmission at 204 and QPSK modulation is employed so that the two-hundred and forty encoded bits are mapped to one-hundred and twenty traffic symbols for transmission.

While processing of the payload bits can be performed after processing of the header bits has been completed the payload bits are processed in parallel with the processing of the header bits to reduce processing latency.

As shown in the Figure, a cyclical redundancy check (CRC) value is first calculated for the payload information bits at 208 and this value is included, with the payload information bits, as part of the bits to be transmitted. In the exemplary system 20, this CRC value is determined from the systematic code generated by a g_{CRC16}(D) function which produces a sixteen bit CRC code, although other suitable CRC functions will be apparent to those of skill in the art.

Next, the information bits and the CRC bits are FEC encoded at 212 and, in the exemplary system 20 this is accomplished with a Turbo coder with subsequent puncturing of the code. As mentioned above, the degree to which the resulting code is punctured is selected according to the reception quality of the intended recipient of the block B that is being constructed. At 216, the resulting bits are interleaved using a Relative Prime Interleaver in the exemplary system 20.

After this coding and interleaving, the bits are mapped to symbols at 224, according to the selected M-ary modulation scheme, where M can be four, sixteen or sixty-four (i.e. 4-QAM, 16-QAM or 64-QAM). Again, the modulation scheme employed is selected according to the reception quality of the intended recipient of the block B being constructed. If the number of bits to be mapped is not divisible by log₂(M), then symbol rate pad bits are added at 220 to fill the available bit space before the symbol mapping at 224.

Next, symbol repetition is performed at 228 at the desired repetition rate, if any. In the exemplary system 20, repetition is performed on a symbol by symbol basis, e.g.—given a sequence of bits s₁, s₂, s₃, s₄ and repetition rate of two, the resulting sequence will be s₁, s₁, s₂, S₂, s₃, s₃, s₄, s₄.

At this point, if the number of symbols to be transmitted is less than the number of traffic symbols available for payload 108, in the exemplary system 20 one thousand and eighty traffic symbols, then DTx padding symbols are appended to the channel symbols at 232. Finally, the channels symbols and the appended DTx padding symbols, if any, are interleaved using a Relative Prime Interleaver at 236 and the resulting traffic symbols are placed in block B at 240, after the header bits (which are not interleaved, i.e.—header bits always appear at the beginning of block B). The resulting block B can then be processed by the physical channel processes for transmission.

In operation, each subscriber station 28 reports its reception quality to base station 24. In the exemplary system 20, a subscriber station 24 reports to base station 40 the signal to noise ratio and/or the frame error rate at which it receives frames 100 of channel 32. This reporting can be performed at an appropriate interval selected by the operator of system 20, as a trade-off exists between the frequency of the reporting, the relevancy/accuracy of the last reported information and the use of the transmission resources between subscriber station 28 and base station 24 for reporting this information.

Reception of a block B at a subscriber station follows an inverse set of operations, as will be apparent to those of skill in the art. It should be noted that de-interleaving of traffic symbols can be performed in parallel with the decoding of the header bits, to reduce overall latency at the receiver.

As mentioned above, header 104 is always packaged into block B in a robust manner to provide a relatively high level of confidence of recovery by all subscriber stations 28a, 28b . . . 28n when frame 100 is transmitted over channel 32. Such robust packaging is intended to allow every subscriber station 28 served by base station 24 to recover header 104. Every subscriber station 28 attempts to decode every block B that it receives, even though the payload 108 may be packaged such that a receiving subscriber station 28 will not normally be able to recover it. In such a case, the CRC code that was included in payload 108 at 208 will be incorrect and the subscriber station 28 will discard the block B. If that block B was intended for the subscriber station, a higher level of the protocol stack employed in system 20 will be responsible for retransmitting the data of that payload 108 to the subscriber station 28 in a subsequent block B as described in detail below.

The payload 108 of a block B can be any type of data received at base station 24. For example, payload 108 can be one or more Transmission Control Protocol/internet Protocol (“TCP/IP”) packets (referred to below as “IP packets”) or part of a segmented packet, where it is desired to transmit IP packets to a subscriber station 28. Payloads 108 can be specifically addressed to a particular subscriber stations 28a, 28b . . . or 28n, each of which has its own unique address and/or one or more broadcast addresses can be defined for subscriber stations with similar reception qualities. Alternatively, broadcast packets can be packaged for the worst reception quality expected for all of the intended receivers. Data in payload 108 can be combined or segmented, as needed, to fit the size restrictions on the payload in a block B.

As data is received by base station 24 for transmission to one or more subscriber stations 28, the data is buffered until a sufficient amount of data is received to fill a frame 100 or until a predefined maximum wait time is exceeded. As will now be apparent to those of skill in the art, the amount of data that is sufficient to fill a frame 100 is dependent upon the Block Format selected to construct each block Bᵢ in a frame 100. It is contemplated that different blocks Bᵢ within a frame 100 will often have different Block Formats as they are intended for different receivers. Thus, the determination of the receipt of a sufficient amount of data is made assuming the best (i.e. most data rate efficient) encoding and modulation operations, or when the predefined maximum wait time has expired from the receipt of the earliest data, this latter parameter being employed to ensure that a frame 100 is assembled and transmitted before a preselected maximum latency period is exceeded. Any received data which cannot be placed into the assembled frame 100, due to the Block Format being less data rate efficient, is buffered and assembled in due course into the next frame 100 to be assembled.

When a sufficient amount of data is received to fill frame 100, including any data that was buffered from the previous frame 100, the reception quality last reported by each intended receiver is used to select an appropriate Block Format for each block B, which are then assembled and inserted into frame 100.

The now-assembled frame 100 is transmitted over channel 32 to subscriber stations 28a, 28b . . . 28n. The transmission can occur in the usual manner, using known techniques.

It is contemplated that system 20 can include more than one channel 32 if desired. In such a case, each channel 32 can have the same spreading factor, or different spreading factors can be employed for different channels 32. For example, one channel 32 can have a spreading factor of four, to enhance, for a given transmission power level, the likelihood of reception at subscriber stations with poor reception qualities while other channels 32 can have spreading factors of eight, sixteen, etc. to provide efficient data transmissions to subscriber stations with better reception qualities.

The above description of the exemplary system 20 explains why in the case of a downlink channel variable amounts of data might be send in frames over a data link. As will become apparent below, the invention is equally applicable to an uplink channel that is subject to being resized. In the network in which the invention is to be implemented, an uplink channel for a subscriber station 28 is resized in accordance with the uplink data demand by the subscriber station 28 and congestion management algorithms.

The system 20 has been described at the lowest level of link layer of the protocol stack. ARQ is provided at a higher level in the link layer. The blocks Bᵢ in a frame 100 referred to above are transport blocks that are handed over to the physical layer of the protocol stack for transmission. In the currently preferred embodiment of the invention, each block B; has a header as described above and carries one or more Medium Access Control (“MAC”) protocol data units (“PDUs”) as a payload. Each MAC PDU in turn has a MAC header (whose description is beyond the scope of this application) and carries a Radio Link Control (“RLC”) PDU as a payload or MAC Service Data Unit (“SDU”). Each RLC PDU, in turn, has an RLC header and a payload, which is referred to below as the RLC SDU. Each RLC SDU is a segment, possibly compressed, of an Internet Protocol (“IP”) packet provided to the link layer by the network layer for transmission.

Broadly described, in the presently preferred embodiment of the invention, ARQ is provided by implicitly dividing the data in each RLC SDU into sequence number blocks and implicitly numbering those blocks. Retransmission of sequence number blocks of an RLC SDU that are reported as lost or corrupted is provided. To determine that a sequence number block is lost or corrupted, the receiving subscriber station (referred to as the “receiver” below and in the claims) looks for a gap in the sequence numbers of the uncorrupted sequence number blocks it has received and provides the base station (referred to as the “transmitter” below and in the claims) with the missing sequence number. The transmitter keeps track of the sequence number blocks that need to be retransmitted as a notional retransmission queue. The details of handling the data to be retransmitted will be evident to those skilled in the art, and can be implemented in a variety of ways. All that is necessary is that the transmitter can keep track of the data that was transmitted in a sequence number block. Whenever the transmitter has room in a frame for data, an RLC PDU is formed from data dequeued from a queue of sequence number blocks that are to be retransmitted and from a queue of data that has not previously been sent.

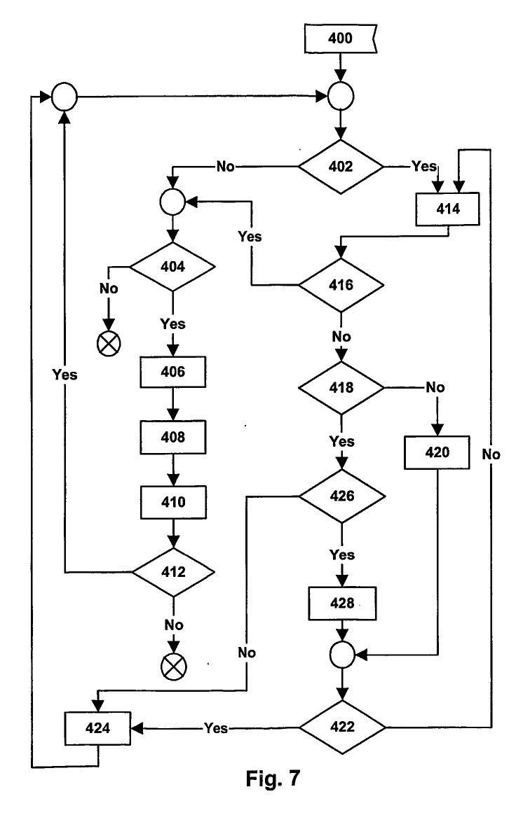

FIG. 7 shows in detail how ARQ is provided in the presently preferred embodiment of the invention. In FIG. 7 and in the following description and claims, an RLC PDU is referred to simply as a “protocol unit”, a RLC header as a “header portion”, and an RLC SDU as a “payload portion”. Further, the details the encapsulation of an RLC PDU in a MAC PDU and the resulting MAC PDU into a block of the frame are omitted as they are outside the scope of the invention. It is assumed that once the frame is formed, it is handed over to lower levels in the protocol stack that are outside the scope of the invention and transmitted to lower levels in the protocol stack running on the receiver. A determination is then made as to whether the protocol unit should be retransmitted and, if so, a command is sent back to the transmitter to retransmit the protocol unit.

Each discrete protocol unit, whether formed from data that is being transmitted for the first time or from data that is being retransmitted, has a data payload portion that is implicitly divided into one or more sequentially numbered blocks (“sequence number blocks”) each having the same fixed length, except possibly the first or the last sequence number block of each protocol unit, which may be shorter. The first sequence number block may be shorter if it is the only sequence number block (in effect, it is also the last sequence number block). The last sequence number block of a protocol unit transmitted for the first time will be shorter if the data-carrying capacity available for the protocol unit in the frame to be transmitted or the remaining data to be transmitted is not an integer multiple of the fixed length. If a protocol unit ending in a short sequence number block is retransmitted in one or more new protocol blocks as discussed in detail below, then the last (or first if there is only one) of the new protocol blocks will end with the short sequence number block. In effect, a sequence number block is the “atomic” unit for retransmissions; it is the smallest amount of data that can be separately retransmitted and may vary in size from one byte up to the maximum sequence number block size. Once data is assigned to a sequence number block, then it stays assigned to that sequence number block, even on retransmission. A consequence of this, as we shall see below, is that if not enough space is left in a frame for the next sequence number block in the queue of data to retransmit, then the space that is available is used to transmit data that has not been previously transmitted and the next sequence number block has to wait for a frame that has enough space.

Each discrete protocol unit also has a header portion that includes the sequence number of the first block in that protocol unit's data payload portion. The header has a fixed length. The sequence numbers are chosen so that all sequence number blocks in transit over the data link at any time can be effectively identified and ordered by the receiver when received. In the current embodiment of the invention, the sequence number blocks are assigned integer sequence numbers in the range from zero to 2^{M}−1 inclusive, where M is 11. Sequence numbers are assigned in ascending order starting (when the system is started up using a reset procedure) from zero and wrapped around to zero when the sequence number reaches 2^{M}−1. Because each protocol unit contains a header portion that includes the sequence number of the first sequence number block in that protocol unit's payload portion and the payload portion is formed from sequence number blocks having known lengths, the receiver can determine the starting and ending sequence numbers of each string of one or more consecutive protocol units that are missing or corrupted. Those starting sequence numbers can then be reported back to the transmitter and the retransmitted in the manner described below.

At block 400 in FIG. 7, a data-carrying capacity of L bytes (all references to “bytes” mean 8-bit bytes) is made available in a frame. (For example, L could be the data-carrying capacity available to carry IP packets.) Then at block 402, a determination is made as to whether there are any sequence number blocks in the retransmit queue. If there are none, then at block 404 a determination is made of whether there is data in the queue of data that has not previously been sent (referred to below as the “new data queue”). If there is, then at block 406 in FIG. 7, the lesser of L bytes or the number of remaining bytes of the IP packet currently being transmitted are dequeued and the number of bytes dequeued subtracted from L. Optionally, boundary of the IP packet currently being transmitted can be ignored, but at the cost of using an expanded header so that the receiver can determine when the IP packet has been fully transmitted and can be provided to higher layers of the protocol stack. Then at block 408, a sequence number for a protocol unit to be added to the frame is then calculated. If this is the first protocol unit to be transmitted over the link since start-up then zero is selected. Otherwise, the sequence number for the protocol unit to be added to the frame is sequence number of the last protocol unit formed plus the ceiling function of the number of bytes in the last protocol unit formed divided by the fixed sequence block length. The protocol unit to be added to the frame is then formed at block 410, including the sequence number just determined in its header portion and the dequeued data in its payload portion, and added to the frame. L is then tested at block 412 and if L is greater than zero, then the retransmit queue is again checked at block 402 to make sure it is still empty. If it is, then the new data queue is again checked at block 404. If the new data queue is not empty (because we ran up against an IP packet boundary L or new data was added to the queue in the meantime), then control continues to block 406 as above and another protocol unit of more bytes from the new data queue is formed at block 410. As before L is tested at block 412 and if L is greater than zero, then the retransmit queue is again checked at block 402. The process is repeated until L reaches zero and the processing stops until space is again available in a frame. It should be noted that ending a protocol unit when the new data queue reaches an IP packet boundary is optional and the invention is not restricted to doing so. The only reason to do so is to reduce the length of the header needed, because if the protocol unit crossed an IP packet boundary the header would have to pass this on to the receiver so that the IP packets would be properly formed.

If, during the process described in the preceding paragraph the retransmit queue is at some point found at block 402 to be non-empty, then the number of bytes in the first sequence number block in the retransmit queue is determined at block 414 and tested against L at block 416. If the number of bytes in the first sequence number block in the retransmit queue is greater than L, then the process described in the preceding paragraph continues at block 404, where the new data queue is checked to determine if there is any data in the new data queue. As before, when L has reached zero or there is no data left in the new data queue and there is either no data to be retransmitted or the next sequence number block is larger than L, then the process ends until space is again made available in another frame.

If at some point in the process described above the retransmit queue is found at block 402 to be non-empty and at block 416 the length of the first sequence number block in the retransmit queue is less than or equal to L, then a determination is made at block 418 in FIG. 7 as to whether a protocol unit is partially formed. If this is not the case, then at block 420 the first sequence number block in the transmit queue is dequeued, L is reduced by the number of bytes dequeued, and a new protocol unit is partially formed with the sequence number of the dequeued sequence number block in the header portion and the dequeued data in the payload portion of new protocol unit. The retransmit queue is then checked at block 422 to determine if it is empty. If the retransmit queue is empty, then at block 424 the new protocol unit is completed and added to the frame and control returns to the point at which the process began at block 402. If the retransmit queue is not empty, then control returns to block 414 at which the length of the sequence number block that is now first in the retransmit queue is determined and then at block 416 compared to L. If the length of that sequence number block is not greater than L, then control proceeds to block 418 where as before it is determined whether a protocol unit is partially formed. The process that takes place if a protocol unit is not partially formed has been dealt above. If a protocol unit is partially formed then at block 426, it is determined whether the sequence number of the sequence number block at the head of the retransmit queue is consecutive with the last block added to the partially formed protocol unit and the last block added to the partially formed protocol unit is the fixed sequence block length. If both of these conditions are true, then at block 428 the sequence number block at the head of the retransmit queue is dequeued and appended to the tail of the partially formed protocol unit and L is reduced by the number of bytes dequeued. If both conditions not true, then at block 424 the partially formed protocol unit is completed and added to the frame and control returns to the point at which the process began at block 402.

As channel capacity changes for a receiver due to changes in the reception quality experienced by the receiver or other causes, the most desirable value for the fixed sequence block length may change for data sent to the receiver. However, in the same system it may be preferable to use a fixed sequence block length that is kept constant under all circumstances for the data sent from the receiver. The following discussion may only apply to data sent to a receiver in that case.

If channel capacity changes for transmission of data to a receiver, (1) transmission of data is suspended until there are no undelivered frames in the link, (2) the receiver is advised of a new value for the fixed sequence block length, and (3) the transmission restarted if the receiver acknowledges receipt of the new value for the fixed sequence block length. The inventor presently prefers to select a new value for the fixed sequence block length when the transport block capacity (the maximum amount of data that can be sent to the receiver in one frame) drops below a threshold that is determined to be “sufficiently near” the fixed sequence block length, or when the transport block capacity increases such that a new fixed sequence block length could be used. For example, a new fixed sequence block length might be calculated if the transport block capacity becomes:
(1) greater than the transport block capacity at the time the current fixed sequence block length was calculated; or
(2) less than the weighted average of
   the transport block capacity at the time the current fixed sequence block length was calculated and the current fixed sequence block length,
where the current fixed sequence block length is given twice the weight of the transport block capacity at the time the current fixed sequence block length was calculated.

Alternatively, a new fixed sequence block length might be calculated if the transport block capacity becomes greater than (1+β) times the current fixed sequence block length or less than [1/(1−α)] times the current fixed sequence block length, where a is set to 0.33 and may range from 0.1 to 0.5 and β is set to 1.0 and may range from 1.0 to 2.0.

A new fixed sequence block length may be determined in the following manner. Clearly, the fixed sequence block length cannot be greater than the transport block capacity. Beyond that, one constraint is that there are only a limited number of sequence numbers (for a given the sequence number space) that can be assigned to sequence number blocks. If you run out of sequence numbers, then further transmissions have to wait until a sequence number can be reused. This is referred to as being by those skilled in the art as being “ack-clocked”, meaning that that the transmission rate is limited by the rate at which acknowledgements are received back from the receiver. For a given sequence number space, whether the transmitter is ack-clocked depends upon the bandwidth-delay product, which is the total amount of data in flight between the transmitter and the receiver. If the bandwidth-delay product is X bytes and there are Y possible sequence numbers, then the sequence number block should not be smaller than X/Y or there will not be enough sequence numbers to avoid ack-clocking. Hence X/Y is the minimum fixed sequence block length for a given sequence number space.

Since a larger sequence number space requires more space in the header of a protocol unit for the sequence number of the first sequence number block, the peak rate at which data carried in the payload portion of protocol units can be transmitted (referred to as the data transmission rate) can be increased by keeping the sequence number space as small as possible and increasing the fixed sequence block length, subject to the fixed sequence block length not becoming larger than the transport block capacity. However, the possibility of the bandwidth-delay product changing during operation has to be considered.

Consider first the absolute optimal selection of the fixed sequence block length if data transmission rate is being maximized. That could be achieved if the bandwidth-delay product could be assumed to be constant The fixed sequence block length could then be set equal to the transport block capacity and the sequence number space set based upon the bandwidth-delay product divided by the fixed sequence block length. This selection of a fixed sequence block length and sequence number space would be inadvisable because a drop in the bandwidth-delay product would cause partial sequence number blocks to the transmitted, increasing the required sequence number space and causing ack-clocking. Even worse, if any sequence number blocks of the fixed sequence block length were in the retransmission queue when the bandwidth-delay product dropped, the retransmission queue would be blocked, effectively blocking all transmission over the channel, until the fixed sequence block length was reset. All of this would detrimentally affect the data transmission rate. On the other hand, setting the fixed sequence block length to the minimum also lowers the data transmission rate because the sequence number space and therefore the header has to be larger than necessary. Some fixed sequence block length larger than the minimum but smaller than the transport block capacity would seem to be desirable.

One solution to the dilemma above is to consider how much-variation in the bandwidth-delay product is likely under normal conditions. Suppose that the fixed sequence block length were set to the transport block capacity at the lowest bandwidth-delay product that could be expected under normal conditions and the sequence number space were calculated based upon the best case bandwidth-delay product that could be expected under normal conditions assuming that fixed sequence block length. The result would be that the fixed sequence block length would be larger than the minimum required for the best case, but the sequence number space would large enough to handle the highest possible bandwidth-delay product.

In the current embodiment of the invention, the sequence number space was fixed initially taking into account the considerations discussed above and other factors such as having headers end on an octet boundary and the sequence number space that is large enough for both uplink and downlink transmissions in a variety of possible situations. Once the sequence number space was fixed, the fixed sequence block length was set based upon the lowest bandwidth-delay product that could be expected under normal conditions and the sequence number space checked to be sure that the ack-clocking would not occur at the highest bandwidth-delay product that could be expected under normal conditions. If necessary, the sequence number space was readjusted. Once a sequence number space was picked, it remains fixed; only the fixed sequence block length is adjusted if the transport block capacity changes. As discussed above the sequence number space in the current embodiment of the invention is 0 to 2^{M}−1 inclusive, where M is 11.

The above-described embodiment of the invention is intended to be an example of the present invention. Alterations and modifications may be effected thereto by those of skill in the art, without departing from the scope of the invention, which is defined solely by the claims appended hereto.

1. A method for transmitting data to a receiver over a data link in frames whose data-carrying capacity may vary from frame to frame, the method comprising transmitting the data in implicitly sequentially numbered blocks transmitted in at least one series of blocks, each series having at least one block, the blocks having lengths determined so that the receiver can identify the blocks by sequence number using the sequence number of the first block of each series of blocks and can individually request retransmission of a lost or corrupted block:

2. The method of claim 1, wherein the sequentially numbered blocks of a series each have a fixed length, except for the last block of a series, or the only block of a series that has only one block, which may be shorter.

3. The method of claim 2, wherein the total number of sequence numbers available for numbering the blocks is pre-selected so that the bandwidth-delay product of the data link under ideal conditions divided by the total number of sequence numbers available for numbering the blocks is not greater than the lowest data-carrying capacity that is reasonably likely to be available in a frame to transmit a series of blocks over the data link during normal operation of the data link.

4. The method of claim 3, wherein the fixed length is initially set to be greater than the bandwidth-delay product of the data link under during normal operation of the data link divided by the total number of sequence numbers available for numbering the blocks and less than the maximum data-carrying capacity that is reasonably likely to be available in a frame to transmit a series of blocks over the data link during normal operation of the data link and is reset if the bandwidth-delay product of the data link changes so that the fixed length is within a predetermined tolerance of the bandwidth-delay product of the data link divided by the total number of sequence numbers available for numbering the blocks or the maximum data-carrying capacity that is available in a frame to transmit a series of blocks over the data link.

5. The method of claim 2, wherein a series of blocks is encapsulated in a protocol unit together with a header that includes the sequence number of the first block of the series of blocks.

6. A method for transmitting data to a receiver over a data link in frames whose data-carrying capacity may vary from frame to frame, the method comprising:
when data-carrying capacity is made available in a frame, transmitting the data in one or more protocol units, each discrete protocol unit having a data payload portion that is implicitly divided into sequentially numbered blocks each having a fixed length, except that the last block, or the only block if the protocol unit has only one block, is shorter if the data payload portion is not an integer multiple in length of the fixed length, and a header portion including the sequence number of the first block in the data payload portion, wherein the sequence numbers are chosen so that all blocks transmitted over the data link can be identified by sequence number by the receiver.

7. The method of claim 6, wherein the total number of sequence numbers available for numbering the blocks is pre-selected so that the bandwidth-delay product of the data link under ideal conditions divided by the total number of sequence numbers available for numbering the blocks is not greater than the lowest data-carrying capacity that is reasonably likely to be available in a frame to transmit a protocol unit having only one block over the data link during normal operation of the data link.

8. The method of claim 7, wherein the fixed length is initially set to be greater than the bandwidth-delay product of the data link under during normal operation of the data link divided by the total number of sequence numbers available for numbering the blocks and less than the maximum data-carrying capacity that is reasonably likely to be available in a frame to transmit a protocol unit having only one block over the data link during normal operation of the data link and is reset if the bandwidth-delay product of the data link changes so that the fixed length is within a predetermined tolerance of the bandwidth-delay product of the data link divided by the total number of sequence numbers available for numbering the blocks or the maximum data-carrying capacity that is available in a frame to transmit a protocol unit having only one block over the data link.

9. The method of claim 6, wherein if it is determined that the receiver did not receive an uncorrupted copy of a previously transmitted protocol unit and there is sufficient data-carrying capacity in the next available frame to be transmitted, then retransmitting the previously transmitted protocol unit in the next available frame before transmitting data that has not been previously transmitted

10. The method of claim 6, wherein if it is determined that the receiver did not receive an uncorrupted copy of a previously transmitted protocol unit and there is sufficient data-carrying capacity in the next available frame to be transmitted, then:
forming a new protocol unit from consecutive blocks of the previously transmitted protocol unit and all consecutive previously transmitted protocol units that are to be retransmitted, starting with the first block of the previously transmitted protocol unit and proceeding sequentially through the previously transmitted protocol units or units adding blocks to the newly formed protocol unit until the data-carrying capacity of the next available frame is used or a block is encountered that is not the fixed length or is larger than the remaining available data-carrying capacity,
transmitting the newly formed protocol unit in the next available frame over the data link, and
in the same manner forming and transmitting further new protocol units whenever data-carrying capacity in a frame is available until all blocks of the previously transmitted protocol unit or units have been successfully retransmitted, each newly formed protocol unit having a header including the sequence number of the first block in its data payload portion.

11. A method for transmitting an IP packet segmented into protocol units to a receiver over a data link in frames whose data-carrying capacity may vary from frame to frame, the method comprising, when data-carrying capacity of L bytes is made available in a frame, the IP packet to be transmitted is in a transmission queue, and any protocol units to be retransmitted are in a retransmission queue, repeating the following until L is zero:
(P) determining whether the retransmission queue is empty (block 402), and
if the retransmission queue is empty, then
(Q) determining whether the transmission queue is empty (block 404), and if the transmission queue is not empty,
dequeuing L bytes or the remaining bytes of the IP packet from the transmission queue, whichever is the lesser, and decrementing L by the number of bytes dequeued (block 406),
calculating a next sequence number (block 408), and
forming a protocol unit having the next sequence number in a header and the dequeued data in a payload, the dequeued data implicitly divided into sequence number blocks consecutively numbered starting at the present sequence number, and adding the protocol unit to the frame to be transmitted, each sequence number block having a fixed length, except if the number of bytes dequeued is not an integer multiple of the fixed length, then the last block, or the only block if the number of bytes dequeued is less than the fixed length, is shorter than the fixed length (block 410),
but if the retransmission queue is not empty,
(R) determining whether the length of the sequence number block at the head of the retransmission queue is greater than L (blocks 414, 416), and
if the length of the sequence number block at the head of the retransmission queue is greater than L, proceeding to the step labeled Q above,
but, if the length of the sequence number block at the head of the retransmission queue is not greater than L, determining whether a new protocol unit is partially formed (block 418), and
if no new protocol unit is partially formed, then
dequeuing the sequence number block at the head of the retransmission queue, decrementing L by the number bytes dequeued, starting the formation of a new protocol unit having the present sequence number in a header and the dequeued sequence number block as a payload (420), and
(S) determining whether the retransmission queue is empty (block 422), and
if the retransmission queue is empty,
(T) completing the new protocol unit and adding it to the frame to be transmitted (block 424), and
proceeding to the step labeled P above, and
if the retransmission queue is not empty,
proceeding to the step labeled R above,
but, if a new protocol unit is partially formed, then
if (i) the sequence number block at the head of the retransmission queue has a sequence number that is consecutive with the sequence number block at the tail of the partially formed protocol unit and (ii) the sequence number block at the tail block of the partially formed protocol unit is the fixed length (block 426), then
dequeuing the sequence number block at the head of the retransmission queue, appending the dequeued sequence number block to the tail of the partially formed new protocol unit, and decrementing L by the number bytes dequeued (block 428), and
proceeding to the step labeled S above,
but otherwise, proceeding to the step labeled T above.

12. A system for transmitting data over a data link, comprising:
(a) a receiver including a microprocessor, a modem, a radio and an antenna, capable of receiving frames transmitted over the data link, the data-carrying capacity of the frames varying from time to time; and
(b) a transmitter including a microprocessor, a modem, a radio and an antenna, operable to transmit frames to the receiver over the data link, the frames including one or more protocol units, each discrete protocol unit having a data payload portion that is implicitly divided into sequentially numbered blocks each having a fixed length, except if the number of bytes carried in the payload portion is not an integer multiple of the fixed length, then the last block, or the only block if the number of bytes in the payload portion is less than the fixed length, is shorter than the fixed length, and a header portion including the sequence number of the first block in the data payload portion, wherein the sequence numbers are chosen so that all blocks transmitted over the data link can be identified by sequence number,
whereby, if it is determined that the receiver did not receive an uncorrupted copy of a previously transmitted protocol unit, then the transmitter retransmits the previously transmitted protocol unit in the next available frame to be transmitted if there is sufficient data-carrying capacity in the next available frame, but otherwise the transmitter
forms a new protocol unit from the blocks of the previously transmitted protocol unit starting with the first block of the previously transmitted protocol unit and proceeds sequentially through the previously transmitted protocol unit adding blocks to the newly formed protocol unit until the data-carrying capacity of the next available frame is used,
transmits the newly formed protocol unit over the data link, and
forms and transmits further new protocol units whenever data-carrying capacity in a frame is available until all blocks of the previously transmitted protocol unit have been successfully retransmitted, each newly formed protocol unit having a header including the sequence number of the first block in its data payload portion.

13. A protocol unit for transmitting data over a data link in frames whose data-carrying capacity may vary from frame to frame to a receiver, the protocol unit comprising a data payload portion that is implicitly divided into sequentially numbered blocks each having a fixed length, except if the number of bytes carried in the payload portion is not an integer multiple of the fixed length, then the last block, or the only block if the number of bytes in the payload portion is less than the fixed length, is shorter than the fixed length, and a header portion including the sequence number of the first block in the data payload portion, wherein the sequence numbers are chosen so that all blocks transmitted over the data link can be identified by sequence number.

14. The method of claim 3, wherein a series of blocks is encapsulated in a protocol unit together with a header that includes the sequence number of the first block of the series of blocks.

15. The method of claim 4, wherein a series of blocks is encapsulated in a protocol unit together with a header that includes the sequence number of the first block of the series of blocks.

16. The method of claim 7, wherein if it is determined that the receiver did not receive an uncorrupted copy of a previously transmitted protocol unit and there is sufficient data-carrying capacity in the next available frame to be transmitted, then retransmitting the previously transmitted protocol unit in the next available frame before transmitting data that has not been previously transmitted.

17. The method of claim 8, wherein if it is determined that the receiver did not receive an uncorrupted copy of a previously transmitted protocol unit and there is sufficient data-carrying capacity in the next available frame to be transmitted, then retransmitting the previously transmitted protocol unit in the next available frame before transmitting data that has not been previously transmitted.

18. The method of claim 7, wherein if it is determined that the receiver did not receive an uncorrupted copy of a previously transmitted protocol unit and there is sufficient data-carrying capacity in the next available frame to be transmitted, then:
forming a new protocol unit from consecutive blocks of the previously transmitted protocol unit and all consecutive previously transmitted protocol units that are to be retransmitted, starting with the first block of the previously transmitted protocol unit and proceeding sequentially through the previously transmitted protocol units or units adding blocks to the newly formed protocol unit until the data-carrying capacity of the next available frame is used or a block is encountered that is not the fixed length or is larger than the remaining available data-carrying capacity,
transmitting the newly formed protocol unit in the next available frame over the data link, and
in the same manner forming and transmitting further new protocol units whenever data-carrying capacity in a frame is available until all blocks of the previously transmitted protocol unit or units have been successfully retransmitted, each newly formed protocol unit having a header including the sequence number of the first block in its data payload portion.

19. The method of claim 8, wherein if it is determined that the receiver did not receive an uncorrupted copy of a previously transmitted protocol unit and there is sufficient data-carrying capacity in the next available frame to be transmitted, then:
forming a new protocol unit from consecutive blocks of the previously transmitted protocol unit and all consecutive previously transmitted protocol units that are to be retransmitted, starting with the first block of the previously transmitted protocol unit and proceeding sequentially through the previously transmitted protocol units or units adding blocks to the newly formed protocol unit until the data-carrying capacity of the next available frame is used or a block is encountered that is not the fixed length or is larger than the remaining available data-carrying capacity,
transmitting the newly formed protocol unit in the next available frame over the data link, and
in the same manner forming and transmitting further new protocol units whenever data-carrying capacity in a frame is available until all blocks of the previously transmitted protocol unit or units have been successfully retransmitted, each newly formed protocol unit having a header including the sequence number of the first block in its data payload portion.
